(19) United States
(12) Patent Application Publication
(10) Pub. No.: US 2006/0003785 A1
(43) Pub. Date: Jan. 5, 2006

(54) Method and system for wireless device association

(75) Inventor: Douglas Mark Zatezalo, Allison Park, PA (US)

Correspondence Address: WOOD, HERRON & EVANS, LLP, 2700 CAREW TOWER, 441 VINE STREET, CINCINNATI, OH, 45202, US

(73) Assignee: Vocollect, Inc., Pittsburgh, PA (US)

(21) Appl. No.: 10/883,441

(22) Filed: Jul. 1, 2004

(51) Int. Cl. H04Q 7/20; H04B 7/00

(52) U.S. Cl. 455/519; 455/517

(57) ABSTRACT

One or more wireless devices operate in an environment having a central manager that controls communications. The wireless devices include respective identifiers and the central manager maintains an association table identifying which identifiers are associated with which other identifiers. The wireless devices are permitted to communicated only with other wireless devices as indicated in the association table.

### TECHNICAL FIELD

The present invention relates to wireless communication devices and, more particularly, to uniquely associating components of such devices with one another.

### BACKGROUND ART

Wireless communications devices are useful in a variety of situations and environments. For example, wireless headsets and terminals are often used in a warehouse or logistics environment to assist workers in their day-to-day activities. Within a warehouse, a worker often will need to travel throughout the facility to pull items from different locations and to place items at different locations. In such an environment, it has proven useful to have a computer that is wearable by the worker having an attached headset and that communicates over a wireless network to a central server.

The headset, which can be wired or wireless provides a microphone to receive speech input from the worker and transmit it to the wearable computer, and a speaker to provide audio output of data received from the wearable computer. As mentioned, the wearable computer is in communication with a central server that can provide data to the wearable computer and receive data from the wearable computer.

In such an environment, there are typically many workers and they are often in close-quarters. Accordingly, when the connection between the headset and the wearable computer is a wireless connection using radio frequencies, cross-talk is sometimes encountered that prevents clear communication for all users. Thus, there is a need unmet in the prior art for multiple wireless devices such as these to communicate without interference.

In addition to the warehouse environment just described, other environments such as, for example, firefighting also involve similar situations. For example, the different pieces of equipment carried by a firefighter often include wireless communications links to a wearable computer that provides a visual display to the firefighter. In such a situation a firefighter would benefit from having the pieces of equipment being associated with his wearable computer be configured to communicate with only that wearable computer.

In the past, some efforts have been made to incorporate functionality within a wireless communications system to uniquely associate devices with a channel of the system. One of these prior art systems includes a terminal, for example in an automobile, that can define four unique channels for wireless telephones in that vehicle. As a result, four people in the vehicle can talk without interference. These and other prior art systems, however, required the terminal and the telephone to include hardware and software that permit them to negotiate the communications channel set-up before being useful. This added functionality increases both the cost and the expense of the wireless devices. Accordingly, there is a need unmet in the prior art for wireless devices that can be assigned unique communications paths without requiring additional functionality, expense and complexity within the wireless device.

### BRIEF DESCRIPTION OF THE DRAWINGS

The accompanying drawings, which are incorporated in and constitute a part of this specification, illustrate embodiments of the invention and, together with the detailed description of the embodiments given below, serve to explain the principles of the invention.

FIG. 1 illustrates an exemplary environment in which wireless devices operate in accordance with the principles of the present invention.

FIG. 2 depicts a flowchart of an exemplary method of associating wireless devices in accordance with the principles of the present invention.

FIG. 3 depicts a flowchart of another exemplary method of associating wireless devices in accordance with the principles of the present invention.

FIG. 4 depicts an exemplary computer platform that supports a system manager or server in accordance with the principles of the present invention.

### DETAILED DESCRIPTION OF SPECIFIC EMBODIMENTS

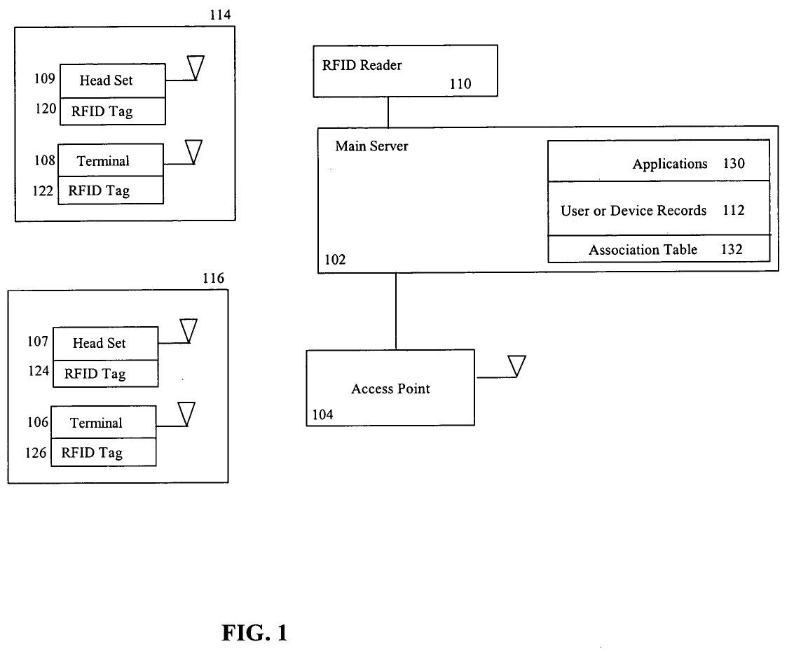

FIG. 1 illustrates an exemplary environment utilizing wireless headsets in accordance with principles of the present invention. In use, a number of pairs of wireless headsets and terminals are used by different operators to communicate with a main server. The main server is able to send messages to a terminal which relays it to its associated headset where audio output is generated. Speech input is generated at the headset, transmitted to the terminal and then relayed to the main server. The link between the terminals and the main server is typically a wireless network that allows multiple terminals to share the spectrum. The link between the terminal and the headset is typically a radio frequency band (e.g. 900 MHz, 2.4 GHz, BlueTooth, etc.) and relies on low-power transmitters to prevent interference between multiple systems.

In particular, the main server 102 is a conventional computer system that can run a variety of applications 130. These applications can relate to the business of maintaining inventory records for a warehouse and can include applications that relate to controlling the communications with the different terminals. These applications are usually integrated with one another to allow voice-controlled operation within the warehouse environment. The application that manages the wireless terminals maintains information about the identification of each terminal so that data can be directed to a desired terminal and information received at the server can be traced to the sending terminal.

In the exemplary environment of FIG. 1, the main server 102 is coupled with one or more access points 104 which are distributed throughout an area serviced by a wireless network such as 802.11b, for example. One of ordinary skill will recognize that a number of wireless network technologies are currently available for implementation as part of the present invention.

Each user within the environment of FIG. 1 includes a wireless terminal 106, 108 and an associated headset 107, 109. FIG. 1 shows a first paired set 114 and a second paired set 116. While only two paired sets are shown in this figure (I.e. representing two different workers), the present invention contemplates dozens of paired sets being used simultaneously. Each pair of a headset 107, 109 and a terminal 106, 108 includes a radio-frequency transmitter and receiver that permits wireless communications between the two devices. Because the terminals 106, 108 and headsets 107, 109 typically use the same frequency range, there can be cross-talk between unpaired headsets and terminals when they are located closely together. When they are spaced far apart, cross-talk is not generally a problem because the signal power level is selected to avoid interference. Exemplary wireless headsets are marketed by the present Assignee as Saturn S3® and exemplary terminals are marketed by the present Assignee as Hercules T2®. Other headsets and terminals having similar capabilities are contemplated within the scope of the present invention as well.

In accordance with the present invention, one approach other than low-power levels is provided to avoid cross-talk between unpaired terminals and headsets. The main server 102 is coupled with a device, such as an RFID reader 110 that can scan RFID tags. Additionally, a respective RFID tag 102, 122, 124, 126 is located on or within the headsets 107, 109 and the terminals 106, 108. The RFID reader 110 and the RFID tags 102-124 are exemplary in nature. One of ordinary skill will recognize that other identification devices such as bar and optical codes, as well as magnetic labels, may be used as well. In operation, the headset 107, 109 and terminals 106, 108 are programmed in such a way that they are aware of their RFID tag identifier. For example, a memory or other mechanism such as dip switches can be used to electronically store an identifier value matching that of the RFID tag.

The RFID reader 110 is used to create an association between a headset and a terminal. For example, the reader 110 will read the RFID tag 120 for the headset 109 and the RFID tag 122 for the terminal 108. Within the main server 102 an association table 132 is created that stores which headsets 107, 109 and which terminals 106, 108 are paired together. This table 132 may be a separate object accessible by a variety of different applications executing on the main server 102 or can be incorporated as part of the terminal management application.

The association for a terminal, e.g., 108, is then transmitted to the appropriate terminal 108 as part of the initial communications set-up that takes place between the main server 102 and the terminal 108. At this point, the terminal 108 is informed of the identity of its paired headset 109 and can send a message addressed to that headset. One advantageous method to address a message to a particular headset is to include in the message a pre-amble portion that includes an identifier. Upon receiving a message, the headset 107, 109 will examine the identifier preamble to determine if the message is addressed to them. However, one of ordinary skill will recognize that a wide variety of other communications protocols, packet-based or not, can be used that include identifier information without departing from the scope of the present invention.

With the initial information exchanged between a paired headset and terminal, these devices can generate messages that identify their intended receiver as well as receive messages that include identifier information therein. Accordingly, messages generated by or received from an unpaired device can be ignored based on the identifier information within the message. Thus, the server creates an exclusive point-to-point communications link between a paired headset and terminal. Communications of these devices with other devices outside of their association are prevented.

The main server 102 can also have access to additional information 112 that is useful for the operation of the terminals 106, 108 or other equipment. For example, in a speech-recognition environment, user-specific models can be downloaded to a terminal 106, 108 based on the identity of its associated user. Or, in a firefighting environment, physical characteristics of a device or equipment can be downloaded from a central repository. In addition, software applications, templates and other information can be sent to the terminal, some of which can be customized based on who is using the terminal. This customization can also be based on the wireless device capabilities and features.

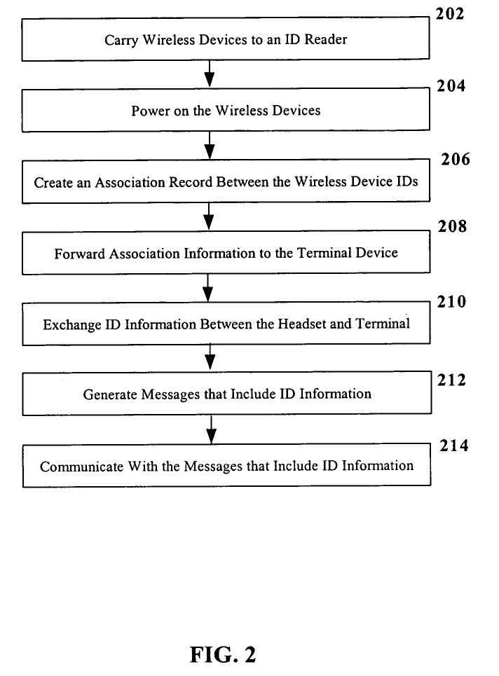

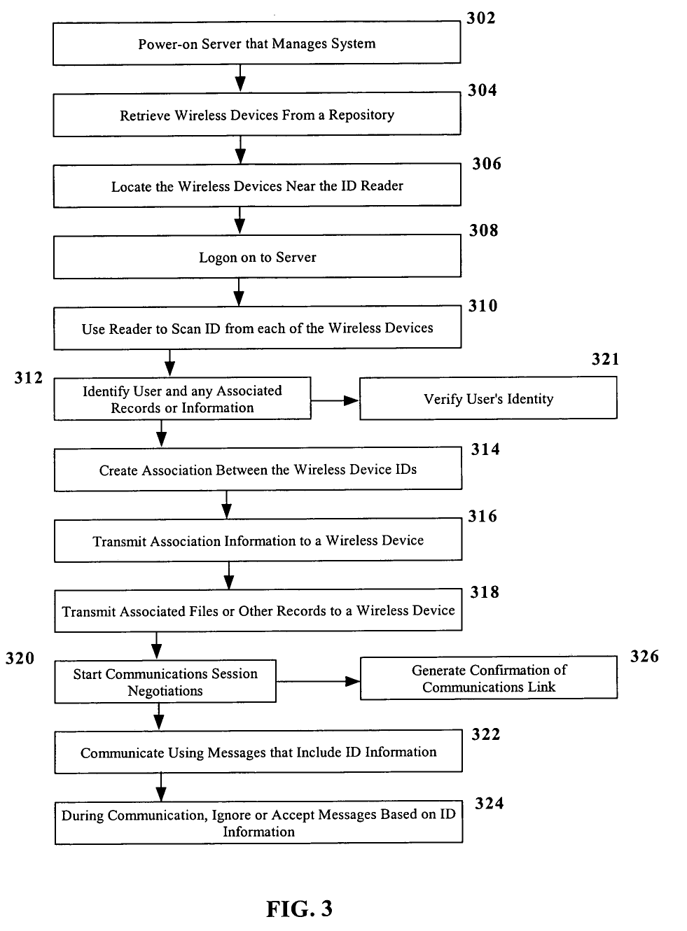

FIGS. 2 and 3 depict a flowchart of an exemplary method of operation of wireless devices in accordance with the principles of the present invention. FIG. 2 provides a high-level view of the method while FIG. 3 highlights advantageous embodiments of the present invention.

In step 202, two wireless devices are brought in close proximity to a reader. For example, in the exemplary warehouse environment, a wireless headset and terminal are carried to an RFID tag reader. Upon power-up of the terminal and headset, in step 204, the RFID reader reads the two tags and passes the information to a central server. The server, in step 206, creates an association between these two RFID tags that is stored for future reference. This association remains active until a re-association is performed by the user: typically by repeating the initial association process.

As part of powering-up the terminal, the terminal and the server create a communications session under the control of a terminal management application or similar software. As part of creating that session, the association information is transmitted from the server to the terminal in step 208.

In the exemplary method of FIG. 2, the terminal informs the headset of the association information in step 210. This step can be accomplished in a variety of different ways. For example, the terminal may send out a message with the headset's identifier in the pre-amble and with the terminals identifier in the body of the message. As a result, when the headset receives the message, it will recognize the message is addressed to it and will disassemble the message to find out the identifier of the sender. Internal programming of the headset will then store the identifier associated with its paired terminal.

In step 212, the terminal and the headset communicate with messages that include identifier information within the message so that each device can discern which messages are intended for them. One method is for each message to contain the identifier of the sender and of the receiver. Thus, a headset can check if a message is addressed to it and if it is being sent from its associated terminal. If either test is false, then the message is ignored.

One alternative that reduces the burden on the headset is to simply include the headset's identifier in each message that is sent to or from the terminal. For example, when a message is sent from a terminal, the message includes the identifier of the intended headset. When the headset receives the message and discovers its identifier within the message, then the headset processes that message without determining which terminal sent it. Conversely, when the headset creates a message to send to the terminal, the headset merely places its identifier in the message. The terminal has the responsibility to determine, when it receives a message, whether the message was sent from its associated headset. One benefit from this embodiment is that the headset does not need to know or store the identifier of its associated terminal.

Regardless of the specific method by which identifiers are embedded into messages, in step 214, the headsets and terminal communicate within the environment of the warehouse. During communication, each device can ignore unintended messages it receives based on identifier information within the message.

The flowchart of FIG. 3 highlights features in addition to those described with respect to FIG. 2. In step 302, the main sever is powered on and operating. In operation, the server, through a combination of software and hardware, is the system manager that controls the operation of all the wireless devices. In step 304, two wireless devices are retrieved from a repository and brought into proximity to a reader, in step 306. The reader is advantageously near the server such that a user can log on to the server, in step 308, while the wireless devices are accessible to the reader. Logging on to the server can be accomplished through a typical username password method, biometric identification, or other security protocol.

In step 310, the reader scans the two wireless devices to determine their respective, associated identifiers. In addition to the reader, a user can manually enter into the server the identifier information about the wireless devices via a keyboard or other input device. In step 312, the server can identify the person associated with this transaction. For example, the login procedure of step 308 can be used to identify the user of the wireless devices. Alternatively, one or more of the wireless devices may be associated with a particular user by default. Thus, even without the login information, when the server sees a particular device identifier scanned in, the server can determine the identity of the user performing the scanning. For example, if a particular wireless terminal (or headset) is usually personally assigned to a particular user, then when the server sees that device's identifier the identity of the user can be determined. Of course, a verification step 321, can be provided that asks the user to confirm that their identity was correctly detected.

In step 314, the reader forwards the two identifiers to the server to create an association between the two devices. One of ordinary skill will recognize the present invention contemplates the association of more than two wireless devices. In such an embodiment, the devices may be configured to permit bi-directional communication between any of the three device or, alternatively, include one terminal and two wireless devices wherein the wireless devices can only communicate with the terminal and not with each other.

In step 316, as part of establishing the communications session with one of the wireless devices, the association information is uploaded to the wireless device from the server. This association information typically includes the identifier information for the associated devices. In step 318, other records can be uploaded from the server to the wireless device. These records can include non-specific files such as general operating system routines and applications that can execute on the wireless device or can include user specific information that customizes the wireless device to the particular user. In this latter instance, the association table maintained by the server has the added dimension of tracking which user is associated with which wireless devices. In a firefighting environment, for example, this information can be used to determine who may be in trouble if a warning or emergency message is received from a particular wireless device.

When the first wireless device receives the association information from the server, then it can open its own communications session with the other wireless device, in step 320. As mentioned previously, the wireless devices can exchange both identifiers or only rely on one identifier to start a communications session. In one advantageous embodiment of the present invention, the wireless devices exchange a confirmation message that indicates the communications session has been effectively established, in step 326. In the warehouse environment, for example, the confirmation may be via an LED lamp on the terminal that is lit (or unlit) depending on whether the headset and terminal have successfully identified one another. Alternatively, the terminal may transmit a message to the headset that is the output via the speaker to indicate the connection is established.

In step 322, the wireless devices then exchange messages substantially as before but include within each message identification information so that receiving devices can determine whether to ignore or accept the message, in step 326.

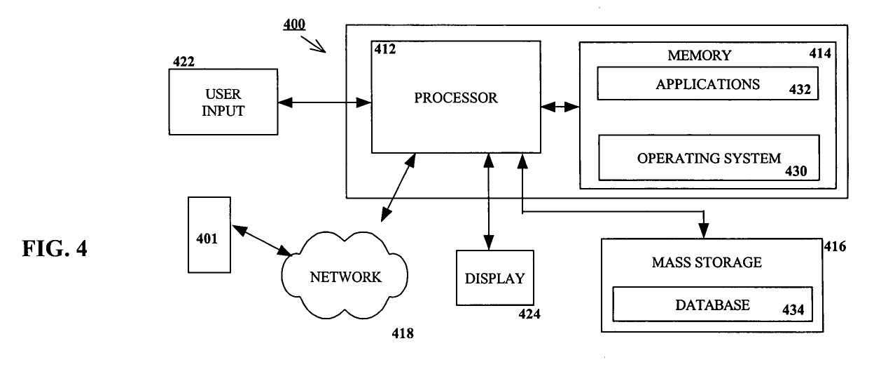

FIG. 4 illustrates an exemplary hardware and software environment for the server or computer 400 suitable for implementing an main server that provides for controlling communications with wireless devices and their respective associations consistent with the invention. For the purposes of the invention, the computer 400 may represent practically any type of computer, computer system or other programmable electronic device, including a client computer, a server computer, a portable computer, a handheld computer, an embedded controller, etc. Moreover, the computer 400 may be implemented using one or more networked computers, e.g., in a cluster or other distributed computing system.

Computer 400 typically includes at least one processor 412 coupled to a memory 414. Processor 412 may represent one or more processors (e.g., microprocessors), and memory 414 may represent the random access memory (RAM) devices comprising the main storage of computer 400, as well as any supplemental levels of memory, e.g., cache memories, non-volatile or backup memories (e.g., programmable or flash memories), read-only memories, etc. In addition, memory 414 may be considered to include memory storage physically located elsewhere in computer 400, e.g., any cache memory in a processor 412, as well as any storage capacity used as a virtual memory, e.g., as stored on a mass storage device 416 or on another computer or device coupled to computer 400 via the Internet 418 or some other network (not shown).

Computer 400 also typically receives a number of inputs and outputs for communicating information externally. For interface with a user or operator, computer 400 typically includes one or more user input devices 422 (e.g., a keyboard, a mouse, a trackball, a joystick, a touchpad, and/or a microphone, among others) and a display 424 (e.g., a CRT monitor, an LCD display panel, and/or a speaker, among others). Otherwise, user input may be received via a workstation 401 used by a resident to access the computer 400 via the network 418, or via a dedicated workstation interface or the like.

For additional storage, computer 400 may also include one or more mass storage devices 416, e.g., a floppy or other removable disk drive, a hard disk drive, a direct access storage device (DASD), an optical drive (e.g., a CD drive, a DVD drive, etc.), and/or a tape drive, among others. Furthermore, computer 400 may include an interface with one or more networks 418 (e.g., a LAN, a WAN, a wireless network, and/or the Internet, among others) to permit the communication of information with other computers and devices coupled to the network. It should be appreciated that computer 400 typically includes suitable analog and/or digital interfaces between processor 412 and each of components 414, 416, 418, 422 and 424 as is well known in the art.

Computer 400 operates under the control of an operating system 430, and executes or otherwise relies upon various computer software applications 432, components, programs, objects, modules, data structures, etc. (e.g., database 434, among others). Moreover, various applications, components, programs, objects, modules, etc. may also execute on one or more processors in another computer coupled to computer 400 via another network, e.g., in a distributed or client-server computing environment, whereby the processing required to implement the functions of a computer program may be allocated to multiple computers over the network.

Other hardware components may be incorporated into system 400, as may other software applications. In general, the routines executed to implement the embodiments of the invention, whether implemented as part of an operating system or a specific application, component, program, object, module or sequence of instructions, or even a subset thereof, will be referred to herein as “computer program code”, or simply [symbol] program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of signal bearing media used to actually carry out the distribution. Examples of signal bearing media include but are not limited to recordable type media such as volatile and non-volatile memory devices, floppy and other removable disks, hard disk drives, magnetic tape, optical disks (e.g., CD-ROM's, DVD's, etc.), among others, and transmission type media such as digital and analog communication links.

In addition, various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein. Those skilled in the art will recognize that the exemplary environment illustrated in FIG. 4 is not intended to limit the present invention. Indeed, those skilled in the art will recognize that other alternative hardware and/or software environments may be used without departing from the scope of the invention.

Thus, a wireless device association system has been described that provides an exclusive point-to-point communications link between two or more wireless devices. Accordingly, cross-talk and other interference between different wireless devices can be avoided Thus, while the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. Thus, the invention in its broader aspects is therefore not limited to the specific details, representative apparatus and method, and illustrative example shown and described. Accordingly, departures may be made from such details without departing from the spirit or scope of applicants' general inventive concept.

For example, the warehouse environment is exemplary in nature. The principles of the present invention can be used for personal communication devices, monitoring systems for parents and children, and with paramedics or firefighters to ensure their equipment effectively communicates and to permit customization of equipment based on the user or other factors.

What is claimed is:

1. A wireless communications system comprising:
at least a first wireless communications device and a second wireless communications device configured to communicate selectively with each other using a respective identifier associated with each device; and
a system manager configured to:
read the respective identifiers;
store the respective identifiers; and
create an exclusive communications link between the at least first and second wireless communications devices.

2. The system of claim 1, wherein the system manager is located in one of the at least first and second wireless communications devices.

3. The system of claim 1, wherein the system manager comprises a server located remotely from the at leas first and second wireless communications devices.

4. The system of claim 1, wherein each of the first and second wireless communications devices include a computer-readable label carrying their respective identifier.

5. The system of claim 4, wherein the computer-readable label is one of an RFID tag, a bar code, a magnetically-readable code and an optically discernable code.

6. The system of claim 1, wherein each of the at least first and second wireless communications devices include a respective memory configured to store their respective identifier.

7. The system of claim 1, wherein the at least first and second wireless devices are configured to provide interactive wireless communication within a work environment.

8. The system of claim 7, wherein the work environment includes a warehouse.

9. The system of claim 1, wherein the at least first and second wireless communications devices include a wireless headset and a wearable terminal.

10. The system of claim 1, wherein the at least first and second wireless devices communicate with each other employing a packet communications protocol utilizing identification information derived from the respective identifiers.

11. A wireless communications system comprising:
at least a first wireless communications device and a second wireless communications device configured to communicate selectively with each other using a respective identifier associated with each device;
a system manager configured to
read the respective identifiers;
store the respective identifiers, and
create an exclusive communications link between the at least first and second wireless communications devices; and
in response to creation of the exclusive communications link, the system manger further configured to transmit to one of the at least first and second wireless communications devices setup information related to operation configuration of that one device.

12. The system of claim 11, wherein the system manager is further configured to identify a user of the one device.

13. The system of claim 12, wherein at least a portion of the setup information is customized based on the user.

14. The system of claim 11, wherein the setup information includes one or more executable applications.

15. The system of claim 11, wherein the system manager is located in one of the at least first and second wireless communications devices.

16. The system of claim 11, wherein the system manager comprises a server located remotely from the at leas first and second wireless communications devices.

17. The system of claim 11, wherein each of the first and second wireless communications devices include a computer-readable label carrying their respective identifier.

18. The system of claim 17, wherein the computer-readable label is one of an RFID tag, a bar code, a magnetically-readable code and an optically discernable code.

19. The system of claim 11, wherein each of the at least first and second wireless communications devices include a respective memory configured to store their respective identifier.

20. The system of claim 11, wherein the at least first and second wireless devices are configured to provide interactive wireless communication within a work environment.

21. The system of claim 20, wherein the work environment includes a warehouse.

22. The system of claim 11, wherein the at least first and second wireless communications devices include a wireless headset and a wearable terminal.

23. The system of claim 11, wherein the at least first and second wireless devices communicate with each other employing a packet communications protocol utilizing identification information derived from the respective identifiers.

24. The system of claim 11, wherein the setup information includes user-specific voice-recognition templates.

25. The system of claim 11, wherein the at least first and second wireless devices operate at one of 900 MHz and 2.4 GHz.

26. The system of claim 11, wherein the at least first and second wireless devices are Bluetooth compliant devices.

27. A method for establishing an exclusive association between more than one wireless components, the method comprising the steps of:
communicating a respective identifier for each of the wireless components to a system manager;
storing in a memory of the system manager an association including the respective identifiers; and
interfering with the operation of the one or more wireless components with another wireless component having a respective identifier not included in the association.

28. The method of claim 27, further comprising the step of:
obtaining the respective identifiers from the one or more wireless components.

29. The method of claim 28, wherein the step of obtaining further includes reading a label containing the identifier.

30. The method of claim 29 wherein the label is one of a magnetic label, a bar code, an optical code; and an RFID tag.

31. A method for exclusive communication between a wireless headset and a terminal, comprising the steps of:
storing at a system manager an association, the association including a first identifier associated with the headset and a second identifier associated with the terminal;
receiving first messages at the terminal transmitted by the headset and ignoring second messages transmitted by another headset; and
receiving third messages at the headset transmitted by the terminal and ignoring fourth messages transmitted by another terminal.

32. The method of claim 31, further comprising the step of:
transmitting fifth messages from the terminal to the headset, wherein the fifth messages include one or both of the first and second identifiers.

33. The method of claim 31, further comprising the step of:
transmitting sixth messages from the headset to the terminal, wherein the sixth messages include one or both of the first and second identifiers.

34. A wireless communications headset, comprising:
a receiver configured to receive incoming messages from one or more wireless terminals, the receiver further configured to ignore incoming messages received from wireless terminals other than a predetermined wireless terminal;
a transmitter configured to transmit outgoing messages to one or more wireless terminals, the transmitter further configured to include within the outgoing messages an identifier value; and
a label including the identifier value.

35. The headset of claim 34, wherein the label is one of an RFID tag, a barcode label, a magnetic label, and a computer-readable label.

36. The headset of claim 34, wherein the transmitter is further configured to include within the outgoing messages a unique identifier of the predetermined wireless terminal.

37. The headset of claim 36, wherein the receiver is further configured to determine if the incoming messages include the identifier value.

38. A wireless communications terminal, comprising:
a receiver configured to receive incoming message from one or more wireless headsets, the receiver further configured to ignore incoming messages received from wireless headsets other than a predetermined wireless headset;
a transmitter configured to transmit outgoing messages to one or more wireless headsets, the transmitter further configured to include within the outgoing messages an identifier value, and
a label including the identifier value.

39. The terminal of claim 38, wherein the label is one of an RFID tag, a barcode label, a magnetic label, and a computer-readable label.

40. The terminal of claim 38, wherein the transmitter is further configured to include within the outgoing messages a unique identifier of the predetermined wireless headset.

41. The terminal of claim 40, wherein the receiver is further configured to determine if the incoming messages include the identifier value.
